(19) United States
(12) Patent Application Publication
(10) Pub. No.: US 2024/0279418 A1
(43) Pub. Date: Aug. 22, 2024

(54) THERMOPLASTIC POLYURETHANE FOAM MATERIAL, MIDSOLE OF ATHLETIC SHOE AND MANUFACTURING METHOD OF FOAM MATERIAL

(71) Applicant: EVERMORE CHEMICAL INDUSTRY CO., LTD., Nantou County (TW)

(72) Inventors: Shih-Wei LIU, Nantou County (TW); Jing-Zhong HWANG, Nantou County (TW); Pin-Jung CHEN, Nantou County (TW); Chang-Yen CHANG, Nantou County (TW); Shih-Chieh WU, Nantou County (TW)

(21) Appl. No.: 18/428,196

(22) Filed: Jan. 31, 2024

(30) Foreign Application Priority Data
Feb. 9, 2023 (TW) 112104670

(51) Int. Cl. C08J 9/00; A43B 5/00; A43B 13/04; C08G 18/12; C08G 18/48; C08J 3/12; C08J 9/12; C08J 9/228

(52) U.S. Cl. CPC C08J 9/0023; A43B 5/00; A43B 13/04; C08G 18/12; C08G 18/4854; C08J 3/12; C08J 9/0071; C08J 9/122; C08J 9/228; C08G 2110/0066; C08G 2410/00; C08J 2201/026; C08J 2203/06; C08J 2203/08

(57) ABSTRACT

A thermoplastic polyurethane foam material, a midsole of athletic shoe and a manufacturing method of a foam material are provided. The thermoplastic polyurethane foam material includes a diphenylmethane diisocyanate, a polytetramethylene ether glycol, a 1,4-butanediol, a nucleating agent and a thinning agent. The thinning agent has a structure represented by formula (I), of which each symbol is defined in the specification.

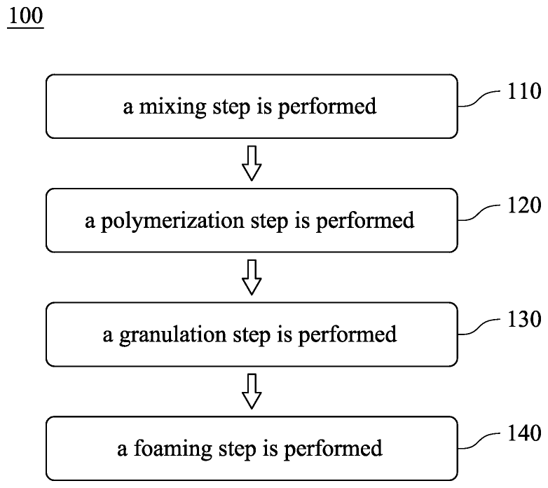

### RELATED APPLICATIONS

This application claims priority to Taiwan Application Serial Number 112104670, filed Feb. 9, 2023, which is herein incorporated by reference.

### BACKGROUND

### Technical Field

The present disclosure relates to a thermoplastic polyurethane foam material. More particularly, the present disclosure relates to a thermoplastic polyurethane foam material with specific thinning agent, a midsole of athletic shoe made of the thermoplastic polyurethane foam material and a manufacturing method thereof.

### Description of Related Art

Foam materials have the advantages such as lightweight, excellent elasticity and good insulation, and the foam materials are commonly used in construction, medical, aerospace and sports industries. In the sports industry, the foam materials can be used for manufacturing sole. The sole meets the requirements such as lightweight, slip resistance, high support and high elasticity, which enhances comfort and safety and improves athletic performance during wear.

Among the foam materials used for manufacturing the sole nowadays, a relatively mature foam material is expanded thermoplastic polyurethane (ETPU) made by a supercritical foaming method of bead foams. The manufacturing process is first making the thermoplastic polyurethane into bead foams by a pressure drop method, filling the bead foams into a mold in a steam chamber, and making the bead foams melt, bond together and foam through heating, pressure reducing, cooling and demolding, so as to form the sole structure.

However, the aforementioned manufacturing process is complicated, which is unfavorable for automation and rapid production and raises safety concerns during operations. Also, the aforementioned manufacturing process has high requirements on materials, often leading to inconsistencies in product dimensions. Additionally, the aforementioned manufacturing process has the disadvantages such as energy-consuming, labor-intensive, and involving bulky equipment.

In this regard, it is a goal for the industry to improve the manufacturing process of the foamed sole structure with great quality.

### SUMMARY

According to one aspect of the present disclosure, a thermoplastic polyurethane foam material includes a diphenylmethane diisocyanate, a polytetramethylene ether glycol, a 1,4-butanediol, a nucleating agent and a thinning agent. The thinning agent has a structure represented by formula (I):

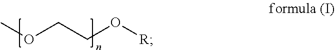

wherein R is a hydrogen atom, an alkyl group with 1 to 5 carbon atoms, R₁—NH₂ or

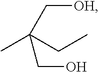

R₁ is an alkyl group with 1 to 5 carbon atoms, and n is a positive integer from 8 to 33.

According to another aspect of the present disclosure, a midsole of athletic shoe is made of the aforementioned thermoplastic polyurethane foam material.

According to one another aspect of the present disclosure, a manufacturing method of a foam material for manufacturing the aforementioned thermoplastic polyurethane foam material includes the following steps. A mixing step is performed by mixing the polytetramethylene ether glycol, the 1,4-butanediol, the nucleating agent and the thinning agent, so as to obtain a polyol mixture. A polymerization step is performed by mixing and heating the diphenylmethane diisocyanate with the polyol mixture, and a prepolymer is formed after the diphenylmethane diisocyanate and the polyol mixture undergo polymerization. A granulation step is performed by shaping and cutting the prepolymer to form a plurality of foaming particles. A foaming step is performed, wherein the plurality of foaming particles undergo foaming to form the thermoplastic polyurethane foam material.

### BRIEF DESCRIPTION OF THE DRAWINGS

The present disclosure can be more fully understood by reading the following detailed description of the embodiment, with reference made to the accompanying drawings as follows:

The FIGURE is a flow chart of a manufacturing method of a foam material according to an embodiment of the present disclosure.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof.

In the present disclosure, the compound structure can be represented by a skeleton formula, and the representation can omit carbon atoms, hydrogen atoms and carbon-hydrogen bonds. If the functional groups are clearly identified in a structural formula, the identified structural formula should be followed.

In the present disclosure, in order to keep conciseness and smoothness, “the thinning agent has a structure represented by formula (I)” can be described as the thinning agent represented by formula (I) or the thinning agent (I) in some cases, and the other compounds or groups can be described in the same manner.

According to one aspect of the present disclosure, a thermoplastic polyurethane foam material includes a diphenylmethane diisocyanate, a polytetramethylene ether glycol, a 1,4-butanediol, a nucleating agent and a thinning agent.

Specifically, a weight ratio of the diphenylmethane diisocyanate in the thermoplastic polyurethane foam material can be 20 wt % to 40 wt %. A molecular weight of the polytetramethylene ether glycol can be 1800 to 3000. A weight ratio of the polytetramethylene ether glycol in the thermoplastic polyurethane foam material can be 50 wt % to 70 wt %. A weight ratio of the 1,4-butanediol in the thermoplastic polyurethane foam material can be 5 wt % to 10 wt %. By controlling the molecular weight or the weight ratios of the diphenylmethane diisocyanate, the polytetramethylene ether glycol and the 1,4-butanediol, the characteristics of the final thermoplastic polyurethane foam material can be adjusted to obtain the desired elasticity, hardness or other processing properties.

The nucleating agent can be nano-scale silica fume or micron-scale talc powder. A weight ratio of the nucleating agent in the thermoplastic polyurethane foam material can be 0.1 wt % to 1 wt %. By selecting the specific nucleating agent, the polymerization of the thermoplastic polyurethane foam material can be improved, and the product of polymerization can have enhanced material properties and reduced appearance defects.

The thinning agent has a structure represented by formula (I):

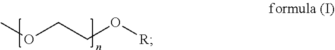

wherein R is a hydrogen atom, an alkyl group with 1 to 5 carbon atoms, R₁—NH₂ or

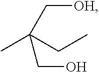

R₁ is an alkyl group with 1 to 5 carbon atoms, and n is a positive integer from 8 to 33. A molecular weight of the thinning agent can be 500 to 1500. A weight ratio of the thinning agent in the thermoplastic polyurethane foam material can be 0.5 wt % to 5 wt %. By selecting the specific chemical structure of the thinning agent in the present disclosure, the solubility of supercritical nitrogen in the thermoplastic polyurethane foam material can be increased. During the injection molding process, supercritical nitrogen can simultaneously be a foaming agent and a plasticizer, which is favorable for improving the foaming effects of the thermoplastic polyurethane foam material. Moreover, when the concentration of supercritical nitrogen in the thermoplastic polyurethane foam material is increased, the dynamic viscosity of the thermoplastic polyurethane foam material can be reduced. Therefore, the flow of the thermoplastic polyurethane foam material in molds can be faster, which reduces appearance defects of foamed products and effectively decreases the density to meet the lightweight requirements, and the foamed products can perform better physical properties.

In the thinning agent represented by formula (I), R is preferably the hydrogen atom, a methyl group, R₁—NH₂ or

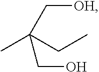

and R₁ is the alkyl group with 1 to 3 carbon atoms. Furthermore, R is more preferably

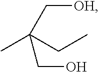

because the aforementioned chemical structure has two hydroxyl groups (—OH) that can react with the diphenylmethane diisocyanate. After reacting with the diphenylmethane diisocyanate, the thinning agent will be in the side-chain position and be easier to contact with supercritical nitrogen, which enhances the overall foaming effects.

According to another aspect of the present disclosure, a midsole of athletic shoe is made of the aforementioned thermoplastic polyurethane foam material. A density of the midsole of athletic shoe can be 0.18±0.02 g/cm³. A hardness of the midsole of athletic shoe can be 45±3. A rebound rate of the midsole of athletic shoe can be greater than 60%. It can be understood that the midsole of athletic shoe made of the thermoplastic polyurethane foam material of the present disclosure has lightweight characteristics, and is able to provide excellent elasticity and enhance comfort and athletic performance during wear.

Please refer to the FIGURE. The FIGURE is a flow chart of a manufacturing method of a foam material 100 according to an embodiment of the present disclosure. According to one another aspect of the present disclosure, the manufacturing method of the foam material 100 includes Step 110, Step 120, Step 130 and Step 140.

Step 110 is performing a mixing step by mixing the polytetramethylene ether glycol, the 1,4-butanediol, the nucleating agent and the thinning agent, so as to obtain a polyol mixture.

Step 120 is performing a polymerization step by mixing and heating the diphenylmethane diisocyanate with the polyol mixture, and a prepolymer is formed after the diphenylmethane diisocyanate and the polyol mixture undergo polymerization.

Step 130 is performing a granulation step by shaping and cutting the prepolymer to form a plurality of foaming particles.

Step 140 is performing a foaming step, wherein the plurality of foaming particles undergo foaming to form the thermoplastic polyurethane foam material. The plurality of foaming particles can undergo foaming through a supercritical nitrogen injection foaming molding method.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### EXAMPLES AND COMPARATIVE EXAMPLES

The thermoplastic polyurethane foam materials of Example 1 to Example 4 and Comparative Example 1 to Comparative Example 4 include the diphenylmethane diisocyanate, the polytetramethylene ether glycol, the 1,4-butanediol, the nucleating agent and the thinning agent. However, the types or proportions of raw materials used in individual Examples/Comparative Examples are different. The properties of each of the raw materials will be explained in the following paragraphs.

Iso1: The diphenylmethane diisocyanate with an isocyanate group content (NCO content) of 33.5% and a molecular weight of 250.

Poly1: The polytetramethylene ether glycol (Dairen Chemical Corp. product No. PTG1000) with a hydroxyl value (OH value; OHv) of 112.2 mg KOH/g and a molecular weight of 1000.

Poly2: The polytetramethylene ether glycol (Dairen Chemical Corp. product No. PTG1400) with a hydroxyl value of 80.1 mg KOH/g and a molecular weight of 1400.

Poly3: The polytetramethylene ether glycol (Dairen Chemical Corp. product No. PTG1800) with a hydroxyl value of 62.3 mg KOH/g and a molecular weight of 1800.

Poly4: The polytetramethylene ether glycol (Dairen Chemical Corp. product No. PTG2000) with a hydroxyl value of 56.1 mg KOH/g and a molecular weight of 2000.

Poly5: The polytetramethylene ether glycol (Dairen Chemical Corp. product No. PTG3000) with a hydroxyl value of 37.4 mg KOH/g and a molecular weight of 3000.

CE1: The 1,4-butanediol with a molecular weight of 90.

VR1: The thinning agent with a hydroxyl value of 90 mg KOH/g and a molecular weight of 1246.

VR2: The thinning agent with a hydroxyl value of 110 mg KOH/g and a molecular weight of 1020.

VR3: The thinning agent with a hydroxyl value of 180 mg KOH/g and a molecular weight of 623.

VR4: The thinning agent with a hydroxyl value of 92 mg KOH/g and a molecular weight of 1219.

The aforementioned thinning agents of VR1 to VR4 have a structure represented by formula (I):

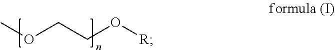

wherein R is

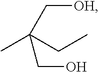

and n is determined according to the molecular weight of each of VR1 to VR4.

F1: The nucleating agent (Nippon Talc Co., Ltd. product No. MICRO ACE SG-95), which is a type of micron-scale talc powder.

F2: The nucleating agent (Evonik product No. AEROSIL R972), which is a type of nano-scale silica fume.

AO1: Antioxidant (BASF product No. Irganox 245).

AO2: Ultraviolet absorber (BASF product No. Tinuvin 329).

W1: Wax (Clariant product No. Licowax E).

Please refer to Table 1 below, which shows the proportions of the raw materials used in the thermoplastic polyurethane foam materials of Example 1 (represented as Ex1), Example 2 (represented as Ex2), Example 3 (represented as Ex3), Example 4 (represented as Ex4), Comparative Example 1 (represented as CEx1), Comparative Example 2 (represented as CEx2), Comparative Example 3 (represented as CEx3) and Comparative Example 4 (represented as CEx4). Blank spaces represent the material is not added to the corresponding example or comparative example.

TABLE 1

| | Ex1 | Ex2 | Ex3 | Ex4 | CEx1 | CEx2 | CEx3 | CEx4 |
|---|---|---|---|---|---|---|---|---|
| | (kg) | (kg) | (kg) | (kg) | (kg) | (kg) | (kg) | (kg) |
| Iso1 | 8.75 | 9.95 | 8.04 | 8.42 | 9.43 | 8.84 | 8.50 | 8.23 |
| Poly1 | | | | | 16.95 | | | |
| Poly2 | | | | | | 17.81 | | |
| Poly3 | | 16.12 | | 18.19 | | | 19.21 | 17.55 |
| Poly4 | 17.98 | | | | | | | |
| Poly5 | | | 19.27 | | | | | |
| CE1 | 2.25 | 2.69 | 2.25 | 2.02 | 1.70 | 1.91 | 2.19 | 1.98 |
| VR1 | | 1.24 | | | | | | |
| VR2 | 1.02 | | | | 1.92 | 1.44 | 0.10 | 2.24 |
| VR3 | | | 0.44 | | | | | |
| VR4 | | | | 1.37 | | | | |
| F1 | 0.019 | 0.0175 | 0.0195 | 0.0195 | 0.019 | 0.0195 | 0.0195 | 0.02 |
| F2 | 0.019 | 0.0175 | 0.0195 | 0.0195 | 0.019 | 0.0195 | 0.0195 | 0.02 |
| AO1 | 0.08 | 0.07 | 0.08 | 0.08 | 0.08 | 0.08 | 0.08 | 0.08 |
| AO2 | 0.10 | 0.09 | 0.10 | 0.10 | 0.09 | 0.10 | 0.10 | 0.10 |
| W1 | 0.038 | 0.035 | 0.039 | 0.039 | 0.038 | 0.039 | 0.039 | 0.04 |
| Total | 30.247 | 30.226 | 30.256 | 30.254 | 30.245 | 30.250 | 30.251 | 30.257 |

Next, the thermoplastic polyurethane foam materials of Example 1 (represented as Ex1), Example 2 (represented as Ex2), Example 3 (represented as Ex3), Example 4 (represented as Ex4), Comparative Example 1 (represented as CEx1), Comparative Example 2 (represented as CEx2), Comparative Example 3 (represented as CEx3) and Comparative Example 4 (represented as CEx4) are made into foamed specimens for further tests. The test results are shown in Table 2 below.

TABLE 2

| | Ex1 | Ex2 | Ex3 | Ex4 | CEx1 | CEx2 | CEx3 | CEx4 |
|---|---|---|---|---|---|---|---|---|
| Melt Flow | 55 | 57 | 60 | 53 | 55 | 56 | 59 | 54 |
| Index | | | | | | | | |
| (g/10 min,/ | | | | | | | | |
| 205° C./8.7 kg) | | | | | | | | |
| Hardness | 42 | 46 | 44 | 47 | 43 | 45 | 48 | 43 |
| Density | 0.162 | 0.181 | 0.173 | 0.193 | 0.165 | 0.179 | 0.197 | 0.168 |
| (g/cm³) | | | | | | | | |
| Tensile | 11.2 | 12.6 | 12.0 | 13.3 | 13.8 | 12.9 | 13.4 | 9.1 |
| Strength | | | | | | | | |
| (kgf/cm²) | | | | | | | | |
| Elongation at | 472.9 | 420.1 | 444.2 | 398.2 | 383.6 | 411.2 | 408.2 | 521.2 |
| Break (%) | | | | | | | | |
| Tear Strength | 5.461 | 6.143 | 5.812 | 6.485 | 6.533 | 6.283 | 6.521 | 4.421 |
| (kgf/cm) | | | | | | | | |
| Rebound Rate | 62 | 60 | 65 | 62 | 53 | 55 | 61 | 50 |
| (%) | | | | | | | | |
| Compression | 22.27 | 23.10 | 20.33 | 21.57 | 19.32 | 23.32 | 24.12 | 30.47 |
| Set (%) | | | | | | | | |
| Pore Size | Pass | Pass | Pass | Pass | Pass | Pass | NG | Pass |
| Evaluation | | | | | | | | |
| Overall | Pass | Pass | Pass | Pass | NG | NG | NG | NG |
| Evaluation | | | | | | | | |

The standards used for the aforementioned tests are as follows: the melt flow index uses DIN 53735 test standard, the hardness uses Type C test standard, the density uses ASTM D297 test standard, the tensile strength uses ASTM D412 test standard, the elongation at break uses ASTM D412 test standard, the tear strength uses ASTM D624 test standard, the rebound rate uses ASTM D2632 test standard, and the compression set uses CNS 3560 test standard.

The pore size evaluation is tested visually by inspecting the cross-section of each of the foamed specimens with an area of 400 cm². The cross-section thereof should not have pores with a diameter exceeding 5 mm, and should not have more than 20 pores with a diameter between 2 mm and 5 mm. If it passes, it is recorded as Pass; otherwise, it is recorded as NG.

The overall evaluation judges whether the foamed specimens meet the physical specifications of the midsole of athletic shoe (that is, the density of 0.18±0.02 g/cm³, the hardness of 45±3, and the rebound rate greater than 60%) and simultaneously pass the aforementioned pore size evaluation. If it passes, it is recorded as Pass; otherwise, it is recorded as NG.

In Table 1 and Table 2, it can be observed that when the molecular weight of the polytetramethylene ether glycol is smaller or the proportion of the thinning agent is too high, the rebound rates of the foamed specimens are significantly insufficient. When the proportion of the thinning agent is too low, noticeable pores are formed, resulting in structural defects in the foamed specimens. Thus, the thermoplastic polyurethane foam material of the present disclosure can performs great material properties by selecting appropriate raw materials and proportions.

In summary, the thermoplastic polyurethane foam material of the present disclosure uses the specific thinning agent, which is favorable for increasing the solubility of supercritical nitrogen in the thermoplastic polyurethane foam material. Also, the dynamic viscosity of the thermoplastic polyurethane foam material can be reduced. The flow of the thermoplastic polyurethane foam material in molds can be faster, which reduces appearance defects of foamed products and effectively decreases the density to meet the lightweight requirements.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A thermoplastic polyurethane foam material, comprising a diphenylmethane diisocyanate, a polytetramethylene ether glycol, a 1,4-butanediol, a nucleating agent and a thinning agent, wherein the thinning agent has a structure represented by formula (I): 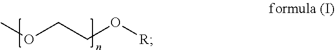
wherein R is a hydrogen atom, an alkyl group with 1 to 5 carbon atoms, R₁—NH₂ or 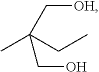
R₁ is an alkyl group with 1 to 5 carbon atoms, and n is a positive integer from 8 to 33.

2. The thermoplastic polyurethane foam material of claim 1, wherein a weight ratio of the diphenylmethane diisocyanate in the thermoplastic polyurethane foam material is 20 wt % to 40 wt %.

3. The thermoplastic polyurethane foam material of claim 1, wherein a molecular weight of the polytetramethylene ether glycol is 1800 to 3000, and a weight ratio of the polytetramethylene ether glycol in the thermoplastic polyurethane foam material is 50 wt % to 70 wt %.

4. The thermoplastic polyurethane foam material of claim 1, wherein a weight ratio of the 1,4-butanediol in the thermoplastic polyurethane foam material is 5 wt % to 10 wt %.

5. The thermoplastic polyurethane foam material of claim 1, wherein the nucleating agent is nano-scale silica fume or micron-scale talc powder, and a weight ratio of the nucleating agent in the thermoplastic polyurethane foam material is 0.1 wt % to 1 wt %.

6. The thermoplastic polyurethane foam material of claim 1, wherein a molecular weight of the thinning agent is 500 to 1500, and a weight ratio of the thinning agent in the thermoplastic polyurethane foam material is 0.5 wt % to 5 wt %.

7. A midsole of athletic shoe, wherein the midsole of athletic shoe is made of the thermoplastic polyurethane foam material of claim 1.

8. The midsole of athletic shoe of claim 7, wherein a density of the midsole of athletic shoe is 0.18±0.02 g/cm³, a hardness of the midsole of athletic shoe is 45±3, and a rebound rate of the midsole of athletic shoe is greater than 60%.

9. A manufacturing method of a foam material, which is for manufacturing the thermoplastic polyurethane foam material of claim 1, comprising:
performing a mixing step by mixing the polytetramethylene ether glycol, the 1,4-butanediol, the nucleating agent and the thinning agent, so as to obtain a polyol mixture;
performing a polymerization step by mixing and heating the diphenylmethane diisocyanate with the polyol mixture, and a prepolymer is formed after the diphenylmethane diisocyanate and the polyol mixture undergo polymerization;
performing a granulation step by shaping and cutting the prepolymer to form a plurality of foaming particles; and
performing a foaming step, wherein the plurality of foaming particles undergo foaming to form the thermoplastic polyurethane foam material.

10. The manufacturing method of the foam material of claim 9, wherein the plurality of foaming particles undergo foaming through a supercritical nitrogen injection foaming molding method.
